(19) United States
(12) Patent Application Publication
(10) Pub. No.: US 2012/0090615 A1
(43) Pub. Date: Apr. 19, 2012

(54) Separably assembled filtering respirator

(76) Inventor: Lin-Pin Chen, Miaoli County (TW)

(21) Appl. No.: 12/923,973

(22) Filed: Oct. 19, 2010

(51) Int. Cl. A62B 7/10; A62B 18/10

(52) U.S. Cl. 128/206.15

(57) ABSTRACT

A filtering respirator includes a main body, a nonwoven fabric lining removably spread in the main body, and an exhalation valve assembled from a front seat, a diaphragm, a middle seat, and a rear seat. The front seat is located in front of the main body; and the diaphragm, the middle seat and the rear seat are sequentially disposed in the nonwoven fabric lining. The middle seat has a front sleeve portion extended through front central openings on the main body and the nonwoven fabric lining to tightly fit in the front seat; and the rear seat is screwed to a rear sleeve portion of the middle seat. Therefore, the exhalation valve can be easily disassembled from the main body to allow replacement of the nonwoven fabric lining while the main body and the components of the exhalation valve can be repeatedly used to meet ecological and economical requirements.

### FIELD OF THE INVENTION

The present invention relates to a filtering respirator, and more particularly to a filtering respirator including an exhalation valve, components of which are separably assembled to a main body of the respirator, allowing easy replacement of a nonwoven fabric lining spread in behind the main body.

### BACKGROUND OF THE INVENTION

To avoid inhaling pollutants in the air, people working in highly contaminated or polluted environments must wear a filtering respirator or face mask. Currently, there are many different filtering respirators and face masks available in the market. These filtering respirators or face masks can be generally divided into two categories according to the structure of an exhalation valve and a main body thereof.

The first type of the currently available filtering respirators or face masks includes integrally formed exhalation valve and main body, such as the exhalation valve and the filtering face mask disclosed in U.S. Pat. No. 5,325,892. A main disadvantage of the filtering face mask disclosed in U.S. Pat. No. 5,325,892 is that the filtering face mask is not repeatedly usable because the exhalation valve is integrally formed with a main body of the filtering face mask. In other words, the exhalation valve and the main body of the used filtering face mask must be discarded at the same time to therefore cause more problems in environmental protection and increase the consumers' burden.

The second type of the currently available filtering respirators or face masks includes separable exhalation valve, filtering piece, and mask main body, such as the replaceable filter respirator disclosed in U.S. Pat. No. 4,630,604. While the replaceable filter respirator disclosed in U.S. Pat. No. 4,630,604 includes a layer of replaceable filter material as well as reusable exhalation valve and respirator main body, it disadvantageously includes a main body made of a non-breathable material with relatively poor softness, such as a rubber material. Such rubber-made respirator main body fails to fitly contact with the user's face and does not absorb sweat, and is therefore less comfortable for wearing. The replaceable filter respirator disclosed in U.S. Pat. No. 4,630,604 also includes complicated components and accordingly requires increased manufacturing cost.

It is therefore tried by the inventor to develop a filtering respirator with separable parts, so as to overcome the disadvantages in the prior art respirators or face masks.

### SUMMARY OF THE INVENTION

A primary object of the present invention is to provide a filtering respirator that allows easy replacement of a face covering portion of the filtering respirator while a main body and an exhalation valve of the filtering respirator are repeatedly usable to meet ecological and economical requirements.

To achieve the above and other objects, the filtering respirator according to the present invention includes a main body, a nonwoven fabric lining, and an exhalation valve.

The main body includes a forward protruded grid-like member defining a space therein, and an outward bent edge portion of a predetermined length formed along a periphery of the grid-like member. Two pairs of through holes are symmetrically provided on two opposite ends of the edge portion, so that two elastic straps may be separately extended through the two pairs of holes to serve as two ear loops or head straps. The forward protruded grid-like member is provided at a front central position with an opening.

The nonwoven fabric lining includes a forward protruded face covering portion made of a nonwoven fabric material with a predetermined thickness and having a configuration corresponding to that of the main body, and an outward bent edge portion of a predetermined length formed along a periphery of the face covering portion. The face covering portion of the nonwoven fabric lining is provided at a front central position with an opening. To assemble the nonwoven fabric lining to the main body, the face covering portion is laid over an inner side of the grid-like member, such that the central opening on the face covering portion is aligned with the central opening on the grid-like member and the edge portion of the nonwoven fabric lining is correspondingly attached to the edge portion of the main body.

The exhalation valve is assembled from a front seat, a diaphragm, a middle seat, and a rear seat.

The front seat includes a forward protruded head portion internally defining a rearward opened inner space, a hollow post rearward projected from an inner side of the head portion, a plurality of through holes spaced along a side wall of the head portion, an outward bent edge portion having a predetermined thickness and extended around a rear rim of the head portion, and a rearward tapered slant wall surface formed in the front seat between the head portion and the edge portion.

The diaphragm is a thin disc made of a rubber material, and is provided at a center with a through hole.

The middle seat includes a forward protruded front sleeve portion and a backward protruded rear sleeve portion, which have identical inner diameter; a radially outward extended flange portion having a predetermined thickness and located between the front and the rear sleeve portion; a rubber cover molded on an outer side of the flange portion; a rearward tapered slant wall surface formed around the middle seat between the front sleeve portion and the flange portion; a plurality of spaced ribs radially extended in the front sleeve portion between an inner wall surface of the front sleeve portion and a pin holder formed at a center of the front sleeve portion; a pin fitted in the pin holder to forward project therefrom; and a plurality of screw threads formed around an outer surface of the rear sleeve portion.

The rear seat includes a rearward protruded and internally threaded sleeve portion adapted to screw to the screw threads on the outer surface of the rear sleeve portion of the middle seat, and an outward bent edge portion having a predetermined thickness and located around a front end of the sleeve portion.

With the above arrangements, the front seat of the exhalation valve cooperates with the middle seat and the rear seat of the exhalation valve to removably hold the main body and the nonwoven fabric lining between them, allowing the filtering respirator to be disassembled and assembled again at any time to facilitate easy replacement of the nonwoven fabric lining without the need of discarding the main body and the exhalation valve.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a filtering respirator according to a preferred embodiment of the present invention;

FIGS. 2 and 3 are assembled rear and front perspective views, respectively, of the filtering respirator of the present invention shown in FIG. 1;

FIGS. 4 and 5 are exploded rear and front perspective views, respectively, of an exhalation valve for the filtering respirator of the present invention;

FIG. 6 is an exploded cross-sectional view of the filtering respirator of the present invention;

FIG. 7 is an assembled view of FIG. 6 with a diaphragm of the exhalation valve in an opened position; and

FIG. 8 is an assembled view of FIG. 6 with the diaphragm of the exhalation valve in a closed position.

### DETAILED DESCRIPTION OF THE PREFERRED EMBODIMENTS

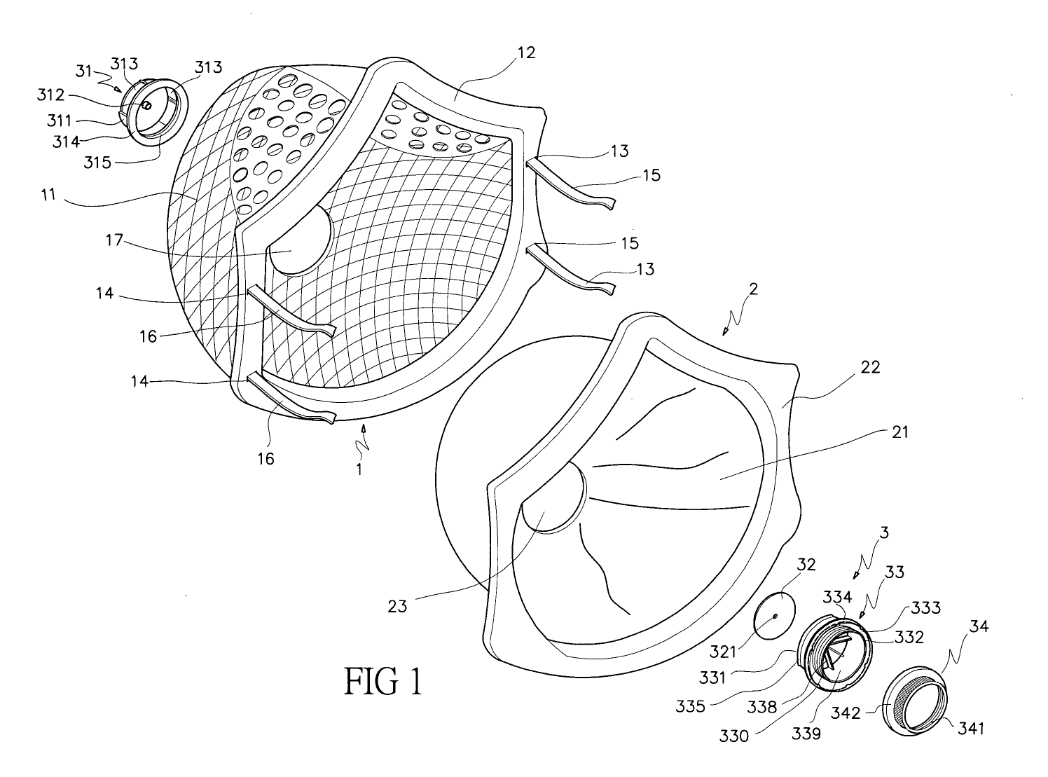

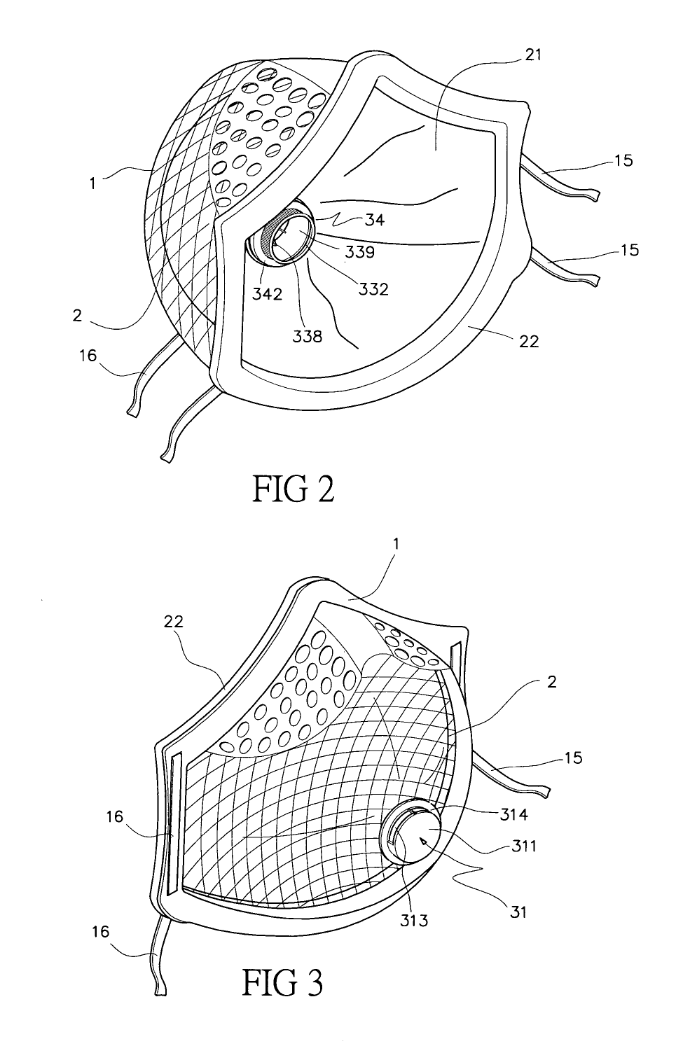

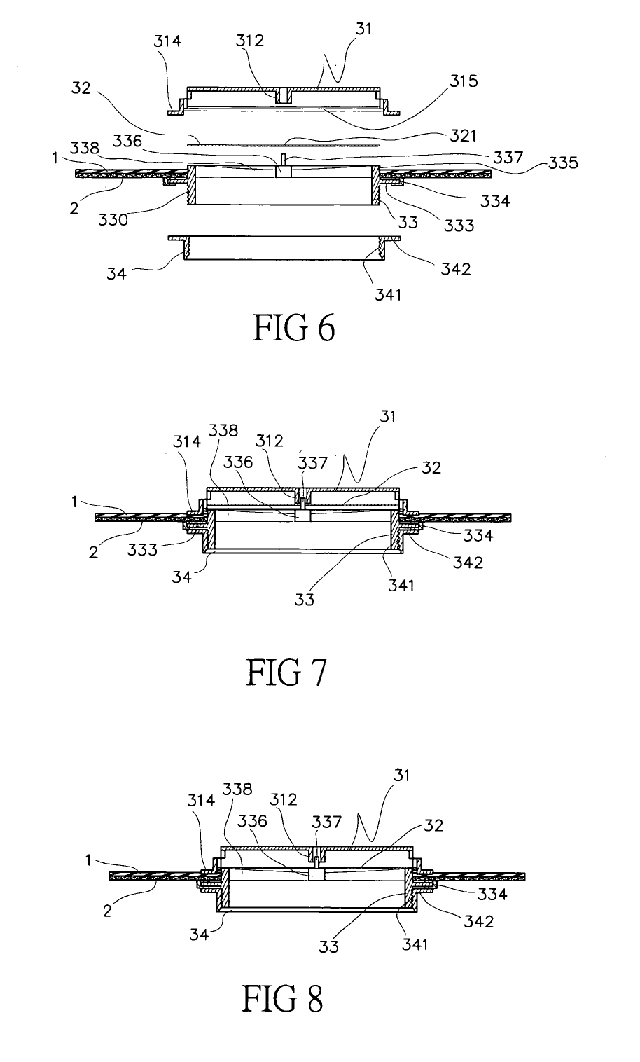

Please refer to FIGS. 1 through 6. A filtering respirator according to a preferred embodiment of the present invention includes a main body 1, a nonwoven fabric lining 2, and an exhalation valve 3.

The main body 1 includes a forward protruded grid-like member 11 defining a space therein, and an outward bent edge portion 12 of a predetermined length formed along a periphery of the grid-like member 11. Two pairs of through holes 13, 14 are symmetrically provided on two opposite ends of the edge portion 12, so that two elastic straps 15, 16 may be separately extended through the two pairs of holes 13, 14 to serve as two ear loops or head straps. The forward protruded grid-like member 11 is provided at a front central position with an opening 17.

The nonwoven fabric lining 2 includes a forward protruded face covering portion 21 made of a nonwoven fabric material with a predetermined thickness and having a configuration corresponding to that of the main body 1, and an outward bent edge portion 22 of a predetermined length formed along a periphery of the face covering portion 21. The face covering portion 21 of the nonwoven fabric lining 2 is provided at a front central position with an opening 23 identical to the opening 17 in size. To assemble the nonwoven fabric lining 2 to the main body 1, the face covering portion 21 is laid over an inner side of the grid-like member 11, such that the central opening 23 on the face covering portion 21 is aligned with the central opening 17 on the grid-like member 11 and the edge portion 22 of the nonwoven fabric lining 2 is correspondingly attached to the edge portion 12 of the main body 1.

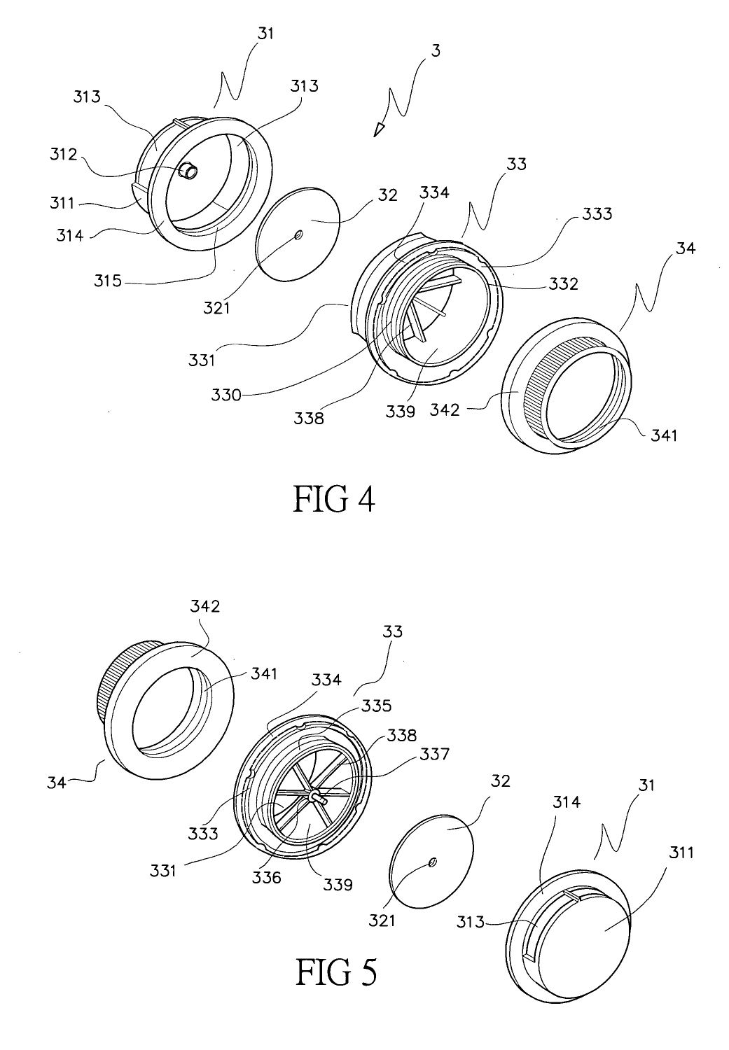

As can be clearly seen in FIGS. 4 and 5, the exhalation valve 3 is assembled from a front seat 31, a diaphragm 32, a middle seat 33, and a rear seat 34.

The front seat 31 includes a forward protruded head portion 311 internally defining a rearward opened inner space, a hollow post 312 rearward projected from an inner side of the head portion 311, a plurality of through holes 313 spaced along a side wall of the head portion 311, an outward bent edge portion 314 having a predetermined thickness and extended around a rear rim of the head portion 311, and a rearward tapered slant wall surface 315 formed in the front seat 31 between the head portion 311 and the edge portion 314.

The diaphragm 32 is a thin disc made of a rubber material, and is provided at a center with a through hole 321.

The middle seat 33 includes a forward protruded front sleeve portion 331 and a backward protruded rear sleeve portion 332, which have identical inner diameter; a radially outward extended flange portion 333 having a predetermined thickness and located between the front and the rear sleeve portion 331, 332; a rubber cover 334 molded on an outer side of the flange portion 333; a rearward tapered slant wall surface 335 formed around the middle seat between the front sleeve portion 331 and the flange portion 333; a plurality of spaced ribs 338 radially extended in the front sleeve portion 331 between an inner wall surface 339 of the front sleeve portion 331 and a pin holder 336 formed at a center of the front sleeve portion 331; a pin 337 fitted in the pin holder 336 to forward project therefrom; and a plurality of screw threads 330 formed around an outer surface of the rear sleeve portion 332.

The rear seat 34 includes a rearward protruded and internally threaded sleeve portion 341 adapted to screw to the screw threads 330 on the outer surface of the rear sleeve portion 332 of the middle seat 33, and an outward bent edge portion 342 having a predetermined thickness and located around a front end of the sleeve portion 341.

As can be seen in FIGS. 1 to 6, to assemble the filtering respirator of the present invention, first spread the face covering portion 21 of the nonwoven fabric lining 2 on the inner side of the grid-like member 11 of the main body 1, such that the central opening 23 at the front end of the face covering portion 21 of the nonwoven fabric lining 2 is aligned with the central opening 17 at the front end of the grid-like member 11 of the main body 1, and the edge portion 22 of the nonwoven fabric lining 2 is correspondingly attached to the edge portion 12 of the main body 1. Then, put the front seat 31 of the exhalation valve 3 in front of the main body 1 and align the rear rim of the head portion 311 at the edge portion 314 of the front seat 31 with the aligned central openings 17, 23 on the main body 1 and the lining 2. Thereafter, sequentially put the diaphragm 32, the middle seat 33 and the rear seat 34 of the exhalation valve 3 in the face covering portion 21 of the nonwoven fabric lining 2 behind the aligned central openings 17 and 23, such that the centered through hole 321 on the diaphragm 32 is engaged with the pin holder 336 on the middle seat 33. Then, apply a forward force to push the slant wall surface 335 on the front sleeve portion 331 of the middle seat 33 into the slant wall surface 315 in the front seat 31 between the head portion 311 and the edge portion 314, so that the front sleeve portion 331 of the middle seat 33 with the diaphragm 32 fitted around the pin holder 336 is tightly fitted in the front seat 31 to unite with the latter, and the pin 337 is received in the hollow post 312 in the head portion 311 of the front seat 31. Finally, fully tighten the internally threaded sleeve portion 341 of the rear seat 34 to the screw threads 330 on the outer surface of the rear sleeve portion 332 of the middle seat 33, so that the exhalation valve 3, the main body 1, and the nonwoven fabric lining 2 are joined together to form the filtering respirator of the present invention. On the other hand, the rear seat 34 of the exhalation valve 3 can be loosened and separated from the middle seat 33 at any time, and the contact surfaces between the front seat 31 and the middle seat 33, that is, the slant wall surface 315 in the front seat 31 and the slant wall surface 335 on the outer side of the front sleeve portion 331 of the middle seat 33, can be pulled apart from each other, allowing the exhalation valve 3, the main body 1, and the nonwoven fabric lining 2 to be quickly separated from one another. At this point, a new nonwoven fabric lining 2 can be used to replace the old one, and the exhalation valve 3, the main body 1 and the new nonwoven fabric lining 2 can be assembled again for use.

FIGS. 7 and 8 show the assembled filtering respirator of the present invention in use. As shown, when a user wearing the filtering respirator of the present invention exhales, the diaphragm 32 of the exhalation valve 3 is pushed forward by the air breathed out, allowing the air to flow out of the respirator via the through holes 313 on the side wall of the front seat 31 of the exhalation valve 3. On the other hand, when the user inhales, the diaphragm 32 is sucked backward to close the respirator.

What is claimed is:

1. A separably assembled filtering respirator, comprising:
a main body including a forward protruded grid-like member defining an inner space, and an outward bend edge portion provided on a periphery of the grid-like member; the edge portion being symmetrically provided at two opposite ends with two pairs of through holes, so that two elastic straps may be separately extended through the two pairs of through holes to provide two ear loops or head straps; and the grid-like member being provided at a front central position with an opening;
a nonwoven fabric lining including a forward protruded face covering portion made of a nonwoven fabric material of a predetermined thickness, and an outward bent edge portion formed along a periphery of the face covering portion; and the face covering portion being provided at a front central position with an opening; and
an exhalation valve being assembled from a front seat, a diaphragm, a middle seat, and a rear seat.

2. The filtering respirator as claimed in claim 1, wherein the front seat of the exhalation valve includes a forward protruded head portion internally defining a rearward opened inner space, a hollow post rearward projected from an inner side of the head portion, and a plurality of through holes spaced along a side wall of the head portion.

3. The filtering respirator as claimed in claim 1, wherein the front seat of the exhalation valve further includes an outward bent edge portion having a predetermined thickness and extended around a rear rim of the head portion.

4. The filtering respirator as claimed in claim 1, wherein the front seat of the exhalation valve further includes a rearward tapered slant wall surface formed in the front seat between the head portion and the edge portion.

5. The filtering respirator as claimed in claim 1, wherein the diaphragm is a thin disk made of a rubber material, and is formed at a central position with a through hole.

6. The filtering respirator as claimed in claim 1, wherein the middle seat of the exhalation valve includes a forward protruded front sleeve portion and a backward protruded rear sleeve portion, which have identical inner diameter; and a radially outward extended flange portion having a predetermined thickness and located between the front and the rear sleeve portion.

7. The filtering respirator as claimed in claim 6, wherein the middle seat of the exhalation valve further includes a rearward tapered slant wall surface formed around the middle seat between the front sleeve portion and the flange portion.

8. The filtering respirator as claimed in claim 6, wherein the flange portion has a rubber cover molded on an outer side thereof.

9. The filtering respirator as claimed in claim 6, wherein the middle seat of the exhalation valve further includes a pin holder formed at a center of the front sleeve portion; and a pin fitted in the pin holder to forward project therefrom.

10. The filtering respirator as claimed in claim 9, wherein the middle seat of the exhalation valve further includes a plurality of spaced ribs radially extended in the front sleeve portion between an inner wall surface of the front sleeve portion and the pin holder.

11. The filtering respirator as claimed in claim 6, wherein the rear sleeve portion of the middle seat of the exhalation valve has a plurality of screw threads formed around an outer surface thereof.

12. The filtering respirator as claimed in claim 11, wherein the rear seat of the exhalation valve includes a rearward protruded and internally threaded sleeve portion adapted to screw to the screw threads on the outer surface of the rear sleeve portion of the middle seat.

13. The filtering respirator as claimed in claim 12, wherein the rear seat further includes an outward bent edge portion having a predetermined thickness and located around a front end of the internally threaded sleeve portion.

14. A separably assembled filtering respirator, comprising a main body, a nonwoven fabric lining, and an exhalation valve; the main body including a grid-like member having a front central opening, the nonwoven fabric lining including a face covering portion having a front central opening, and the exhalation valve including a front seat, a diaphragm, a middle seat and a rear seat; wherein the front seat, the diaphragm, the middle seat and the rear seat of the exhalation valve are separably assembled to the main body and the nonwoven fabric lining, such that the face covering portion of the nonwoven fabric lining is spread over an inner side of the grid-like member of the main body with the front central openings of the grid-like member and the face covering portion aligned with each other, the front seat of the exhalation valve is externally located in front of the main body to align with the two aligned front central openings, the diaphragm, the middle seat and the rear seat of the exhalation valve are sequentially disposed in the face covering portion of the nonwoven fabric lining behind the two aligned central openings, the diaphragm is engaged at a centered through hole with a pin holder provided on the middle seat, a rearward tapered slant wall surface formed on a front sleeve portion of the middle seat is forwardly tightly fitted in a rearward tapered slant wall surface formed in the front seat around a rear rim thereof for the middle seat and the front seat to unite with each other, and the rear seat is connected at an internally threaded sleeve portion to an externally threaded outer surface of a rear sleeve portion of the middle seat; whereby the exhalation valve, the main body, and the nonwoven fabric lining are joined together to form the filtering respirator.
